(19) United States
(12) Patent Application Publication
(10) Pub. No.: US 2003/0060387 A1
(43) Pub. Date: Mar. 27, 2003

(54) Water-soluble package with fluorescent dye in the film

(75) Inventors: Feng-Lung Gordon Hsu, Tenafly, NJ (US); Edward John Giblin, Hopatcong, NJ (US); Kwang H. Lee, Park Ridge, NJ (US)

Correspondence Address: UNILEVER, PATENT DEPARTMENT, 45 RIVER ROAD, EDGEWATER, NJ, 07020, US

(73) Assignee: Unilever Home and Personal Care, USA, Division of Conopco, Inc.

(21) Appl. No.: 09/957,329

(22) Filed: Sep. 20, 2001

(51) Int. Cl. C11D 17/00

(52) U.S. Cl. 510/296; 510/301

(57) ABSTRACT

A water-soluble single-use package for a detergent composition comprising a fluorescent dye of limited water solubility in the water-soluble body portion. Preferred detergent compositions are low water-content liquid detergent compositions. A process of preparing a water-soluble film containing a fluorescent dye is also disclosed.

### FIELD OF THE INVENTION

A water-soluble single-use package for a detergent composition comprising a fluorescent dye in the water-soluble body portion and a process of its preparation.

### BACKGROUND OF THE INVENTION

Detergent compositions are provided in many forms, of which granular and liquid compositions are the most prevalent. More recently, unit dose forms of detergent have been proposed in the form of compressed tablets of detergent powder or water-soluble packages, which are entirely consumed during a single cleaning application. The unit dose forms are preferred by some consumers, in that the dose is pre-measured and, consequently, the unit dose form is faster, easier and less messy to use. Water-soluble packages filled with liquid detergent composition are desired especially by consumers who are used to liquid detergents.

Water-soluble unit dose liquid detergent packages are known. See, for instance, Kennedy (U.S. Pat. No. 4,973,416), Dickler et al. (U.S. Pat. No. 6,037,319), Haq (U.S. Pat. No. 4,416,791) and Richardson (U.S. Pat. No. 4,115,292).

Polyvinyl alcohol films containing various additives, for instance pigments and UV absorbers, are known. See Morita et al. (U.S. Pat. No. 5,498,656), Ohtsu et al. (U.S. Pat. No. 5,582,916), Gray (U.S. Pat. No. 3,528,921), JP 11189660, JP1116701, JP 11029680, JP 8151455 and Miyazaki (U.S. Pat. No. 6,166,117).

Incorporation of F-dye into plastic bottles or water-insoluble films has been described. For instance, WO 01/49575 discloses transparent/translucent bottles containing fluorescent dye in sidewall. Hanada et al. (U.S. Pat. Nos. 5,904,974 and 5,922,808) disclose a water-proof PVA copolymer which may include a variety of optional ingredients including fluorescent whitening agent. Likewise, Kinoshita et al. (U.S. Pat. No. 5,824,394) describe a polyester film, used as an adhesive, which may contain F-dye.

The use of fluorescent dyes (also known as whitening agents, or fluorescent whiteners, or brighteners, or optical brighteners, or F-dyes) in laundry applications to whiten fabrics is widespread. See, for instance, Hunter et al. (U.S. Pat. No. 5,234,617). With the aid of F-dyes, optical compensation of the yellow cast that develops on substrates such as fabric can be achieved. The yellow cast is produced by the absorption of short-wavelength light (violet-to-blue). F-dyes replace, at least in part, this lost light, so a complete white is attained. This additional visible light is produced by the F-dye by means of fluorescence. F-dyes absorb the invisible ultraviolet portion of the daylight spectrum and convert it into the longer-wavelength visible wavelength.

F-dye must be carried on the laundered article's surface, and thus the F-dye preferably has limited water solubility, so that it may survive the wash cycle. Incorporation of such low soluble F-dyes into liquid laundry formulations with low water content presents a problem, however, since the limited water solubility of the F-dye causes its precipitation. For instance, the water content below 15% may cause F-dye precipitation. Precipitation is, of course, undesirable, because it reduces the visual appeal of the product and prevents the uniform dosage of the F-dye. The present invention is based, in part, on the discovery that F-dyes may be successfully incorporated into a water-soluble body portion of the water-soluble package containing a detergent composition, thus avoiding the precipitation and increasing the visual appeal of the package. The visual appeal of the package is increased partially due to the avoidance of the precipitation inside the package. Also, the inventors discovered that incorporation of F-dye into a water-soluble film resulted in a film that was visually virtually the same as the film without the F-dye, yet, surprisingly, the limited solubility F-dye was distributed through the film in a substantially continuous and uniform manner.

### SUMMARY OF THE INVENTION

The present invention includes a water-soluble package for use in a single cleaning application comprising a detergent composition contained within a water-soluble body portion, the body portion comprising a water-soluble film composition, the film composition comprising a fluorescent dye of limited solubility.

Preferred detergent compositions are liquid, preferably containing less than 20% water (since such low water compositions cause the greatest precipitation of the F-dye). The most preferred compositions are transparent/translucent and are contained within a transparent/translucent body portion.

In another aspect, the invention relates to a process of preparing a water-soluble film, with a fluorescent dye distributed substantially continuously therein.

The following detailed description and the examples illustrate some of the effects of the inventive compositions. The invention and the claims, however, are not limited to the following description and examples.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

For the avoidance of doubt the word “comprising” is intended to mean including but not necessarily “consisting of” or “composed of.” In other words the listed steps or options need not be exhaustive.

The term “substantially continuous” as used herein means that when the film containing the F-dye is exposed to UV light, the light source in the film is continuous, without visible breaks.

The term “transparent” as used herein includes both transparent and translucent and means that an ingredient, or a mixture, or a phase, or a capsule, or a composition, or a package according to the invention preferably has a transmittance of more than 25%, more preferably more than 30%, most preferably more than 40%, optimally more than 50% in the visible part of the spectrum (approx. 410-800 nm). Alternatively, absorbancy may be measured as less than 0.6 (approximately equivalent to 25% transmitting) or by having transmittance greater than 25% wherein % transmittance equals: 1/10^{absorbancy}×100%. For purposes of the invention, as long as one wavelength in the visible light range has greater than 25% transmittance, it is considered to be transparent/translucent.

### Water-soluble Body Portion

The package is preferably made of a clear, heat sealable, cold water soluble film such as polyvinyl alcohol. Thickness could range from 25 to 100 μm, more preferably from 35 to 80 μm, most preferably from 45 to 55 μm. Other materials from which the package can be made include but are not limited to methyl hydroxy propyl cellulose and polyethylene oxide. Polyvinyl alcohol is preferred due to its ready availability and low cost.

The water-soluble film, at least of the body wall, is thermoformable and, in one embodiment of the invention, is polyvinyl alcohol, or a polyvinyl alcohol derivative. Preferably the water soluble film of the base wall is the same material as that used to make the body wall. Both thermoforming and cold forming (e.g., with water) are possible.

### F-dye

According to the present invention, the water-soluble body portion includes an F-dye within the water-soluble film of the water-soluble body portion.

F-dyes suitable for present invention have a limited solubility (so that they can survive the wash cycle and be deposited on the clothes). Some solubility is desirable, however, so that the F-dye may be incorporated into the film according to the inventive method (described below) which achieves optimum substantially continuous and uniform distribution of the F-dye in the film. Typical suitable solubility is less than 6% at 25° C. in distilled deionized water, preferably no more than 4%, to obtain maximum whitening benefit on laundered items. It is preferred to use F-dyes, however, that have some solubility, preferably at least 0.0001%, more preferably 0.005%, in order to obtain a continuous distribution within the film.

Suitable F-dyes include but are not limited to the following classes of compounds, as long as they satisfy the solubility requirements described above: Carbocycles (e.g. Distyrylbiphenyl, Distyrylbenzene, Divinylstilbene), Furans, Benzofurans (e.g., Bis(benzo[b]furan-2-ylbiphenyls), 1,3-Diphenyl-2-pyrazolines, Coumarins, Naphthalimides; Carbostyril compounds; 1,3-diphenyl-2-pyrazolines; benzadyl substitution products of ethylene, phenylethylene, stilbene, thiophene; and combined hateroaromatics. Among F-dyes which may be used are also the sulfonic acid salts of diamino stilbene derivatives such as taught in U.S. Pat. No. 2,784,220 to Spiegler or U.S. Pat. No. 2,612,510 to Wilson et al., both of which are hereby incorporated by reference. These are preferred because of their limited solubility, but other F-dyes may be employed as long as they satisfy the solubility requirements.

The most preferred F-dyes are selected from stilbenic type: 4,4′-Bis anilino-6 [bis (hydroxyethylmethyl) amino]-s-triazin-2-yl amino 2,2′ stilbenedisulfonic acid, available as Tinopal® 5BM-GX from Ciba-Geigy; 4,4′-Bis anilino-6 [bis (22-hydroxyethyl) amino]-2-triazin-22-yl amino-2,2′ stilbenedisulfonic acid, available as Tinopal® UNPA-GX from Ciba-Geigy), Cyanuric chloride/diaminostilbene types such as Tinopal AMS, DMS, 5BM, and UNPA from Ciba Geigy Corp. and Blankophor DML from Mobay and Distyrylbiphenyl type (e.g. Benzenesulfonic acid, 2,2′-biphenyl]-4,4′diyldi-2,1-ethenediyl) bis-, disodium salt, available as Tinopal® CBS-X from Ciba-Geigy). Tinopal® 5BM-GX is the most preferred due to its optimum low water solubility.

The water-soluble film generally includes from 0.01 to 20% of the F-dye, more preferably from 0.05% to 10%, most preferably from 0.1 to 5%, and optimally from 0.15 to 2%, in order to deliver optimum whitening benefits (% by weight of the film).

The UV-absorber protects the contents of the package during storage. Also, in the wash, the UV-absorber is deposited on the clothes, to protect the clothes from harmful UV-rays and to screen the UV-rays from the body of a person wearing the clothes. A highly preferred optional ingredient to be included in the film is a UV-absorber, from 0.001 to 5%, by weight of the film. Among families of UV absorbers which may be used are benzophenones, salicylates, benzotriazoles, hindered amines and alkoxy (e.g., methoxy) cinnamates. Recitation of these classes is not meant to be a limitation on other classes of UV absorbers which may be used.

Water soluble UV absorbers particularly useful for this application include, but are not limited to: phenyl benzimidazole sulfonic acid (sold as Neo Heliopan®, Type Hydro by Haarmann and Reimer Corp.), 2-hydroxy-4-methoxybenzophenone-5-sulfonic acid (sold as Syntase® 230 by Rhone-Poulenc and Uvinul® MS-40 by BASF Corp.), sodium 2,2′-dihydroxy-4,4′-dimethoxy-5-sulfobenzophenone (sold as Uvinul® DS-49 by BASF Corp.), and PEG-25 paraaminobenzoic acid (sold as Uvinul® P-25 by Basf Corp.) and Tinuvin® family of UV-absorbers from Ciba-Geigy.

### Incorporation of F-dye into the Film

Any known method may be employed, but preferably, in order to attain substantially continuous distribution of the F-dye in the water-soluble film, the inventive method is employed:

F-dye is dissolved at an elevated temperature (typically, from 20° C. to 70° C., preferably 30 to 60° C., in a polar hydrophilic solvent, preferably water, e.g., deionized water. The concentration of F-dye in the solvent is typically in the range of from 0.001 to 5%, more preferably from 0.001 to 2%. This is followed by the addition of water-soluble resin. The mixture is agitated and kept at the temperature 65.6° C. until the resin is fully dissolved. The resulting solution is then cast onto a flat plate with a spatula and dried to obtain the film with an F-dye on it.

The continuous distribution is advantageous, in order to attain the uniform appearance of the film and better cast due to the absence of particles. Other methods include melt cast or melt-blown processing.

### Detergent Composition

Various detergent compositions include, but are not limited to laundry compositions, hard surface cleaners, dishwashing compositions. In a particularly preferred embodiment of the invention the fluid composition is a laundry treatment such as a laundry detergent.

Preferred laundry compositions comprise a surfactant, in an amount from 1 to 80% more preferably from 15 to 75%, most preferably from 20 to 70%, and optimally from 50 to 70% (% by weight of the laundry composition). Suitable detergent and laundry surfactants are well known to one of ordinary skill in the art and may in general be chosen from anionic, nonionic, amphoteric, and cationic surfactants. Preferably, the surfactant in the laundry compositions is anionic and/or nonionic, especially linear alkylbenzene sulfonate, alkyl ether sulfate, especially, alcohol ethoxylates and mixtures thereof.

In addition to the surfactant, the preferred laundry composition may include one or more well-known laundry ingredients, such as builders (from 0.1 to 40% for powders, from 0.1 to 20% for liquids), anti-redeposition agents, fluorescent dyes, perfumes, soil-release polymers, colorant, enzymes, buffering agents, etc.

The fluid compositions include some water, typically 0.1 to 20% water. While the invention is suitable for detergent compositions of any water content, it is particularly useful for detergent compositions of very low water content, e.g. water content of from 0.1 to 15% by weight of the composition, preferably from 2 to 10%.

Fine fluid compositions may optionally contain an F-dye and/or UV-absorber in addition to those contained in the film.

Preferably, the detergent composition is a transparent/translucent composition packaged in the transparent/translucent film containing a limited solubility F-dye.

The packages of the invention may be prepared from polyvinyl alcohol film, or other suitable material, which is filled, then sealed, preferably heat-sealed or water-sealed.

The package may take many shapes as viewed in a plan view, such as rectangular, square, round, triangular, etc.

In use, the package is mixed with water (e.g., inside a laundry machine or a dishwasher), in order to release the contents of the package and to dissolve the film, thus also releasing the F-dye. Subsequently, R-dye is deposited on the laundry, to deliver the whitening benefit.

The following specific examples further illustrate the invention, but the invention is not limited thereto.

### EXAMPLE 1

### Comparative

In most heavy duty liquid laundry detergents, a small amount of fluorescent dye (F-dye) is added to the base to reduce the yellowing of the fabric. The F-dye works by depositing itself on clothing, thus, a low water solubility F-dye is preferred for its efficacy. But the same type of dyes has a tendency of precipitating out of a low water content liquid laundry detergent.

A formula listed in Table 1 was prepared by mixing the ingredients in the order listed. Monoethanolamine Oleate and Monoethanolamine LAS were prepared in-situ by reacting monoethanolamine ex. Dow with Oleic acid ex. Unichema and LAS acid ex. Stepan, respectively.

TABLE 1

| Raw Material | % in formula |
|---|---|
| Neodol 1-5 ex. Shell Chemical | 26.83 |
| Monopropylene Glycol ex. Eastman Chemical | 5.54 |
| Glycerol ex. Unichema | 21.53 |
| Monoethanolamine Oleate | 16.06 |
| Softened Water | 3.30 |
| Monoethanolamine LAS | 24.9 |
| Tinopal ® 5BM-GX ex. Ciba-Geigy Corp. | 0.21 |
| Miscellaneous | 1.63 |
| Total | 100.00 |

The F-dye, Tinopal® 5BM-GX (4,4′-Bis anilino-6-[bis (hydroxyethylmethyl) amino]-s-trizin-2-yl amino-2,2′stilbenedisulfonic acid) precipitated out of this low water content liquid laundry detergent. It is known that Tinopal® 5BM-GX is moderately soluble in water (1.5% at 48.9° C.) and is anionic in nature.

### EXAMPLE 2

To demonstrate the incorporation of F-dye without the appearance of precipitation in a low water content liquid detergent, Tinopal® 5BM-GX was added to the PVA film, according to the present invention.

PVA film containing F-dye was prepared as follows:

1.67 g of Tinopal® 5BM-GX was dissolved at 65.6° C. in 365 g of deionized water in a 600 ml beaker; followed by the addition of 100 g of C120-T PVA resin ex. PVAXX. The mixture was agitated and kept at the temperature 65.6° C. until the PVA resin was fully dissolved. 100 g of the solution is then cast onto a copper plate with a spatula. The plate was then placed in an oven set at 60° C. for about 30 minutes. The film was removed with a razor blade and weighted. The weight loss was 70.11 g or the weight of the film was 29.89 g. The appearance of the film was about the same as the PVA film without F-dye. The final composition of the film that was prepared is shown in Table 2:

TABLE 2

| Ingredient | % |
|---|---|
| C-120T PVA ex. PVAXX | 86.31 |
| Water | 8.10 |
| Tinopal ® 5BM-GX ex. Ciba-Geigy | 5.59 |
| Total | 100 |

The film was examined by a UV lamp (Blak-Ray ML-49 by UVP, Inc). Under the UV light, the whole film was completely and evenly covered with blue-violet color, which indicated the continuous and even distribution of F-dye.

What is claimed is:

1. A water-soluble package for use in a single cleaning application comprising:
(a) a detergent composition for release on dissolution of the package,
(b) a water-soluble body portion for containing the composition, the body portion comprising a water-soluble film composition, the film composition comprising from about 0.01% to about 20% by weight of the film composition, of a fluorescent dye which has a solubility in distilled deionized water at 25° C. of less than about 6%.

2. The package of claim 1 wherein the fluorescent dye is substantially continuously distributed through the film composition.

3. The package of claim 1 wherein the fluorescent dye has a solubility in distilled deionized water at 25° C. of less than 4%.

4. The package of claim 1 wherein the film composition further comprises a UV-absorber.

5. The package of claim 1 wherein the body portion is transparent/translucent.

6. The package of claim 1 wherein the detergent composition is fluid.

7. The package of claim 6 wherein the fluid composition comprises less than 20% of water, by weight of the composition.

8. The package of claim 1 wherein the detergent composition is a laundry composition.

9. A process of preparing a water-soluble film comprising a fluorescent dye, the process comprising:
(a) preparing a solution of a fluorescent dye in a hydrophilic solvent;
(b) adding a water-soluble resin to the solution, to obtain a solution comprising both the fluorescent dye and the water-soluble resin;
(c) casting and drying the solution to obtain the water-soluble film with the fluorescent dye distributed substantially continuously therein.
